(19) United States
(12) Patent Application Publication
(10) Pub. No.: US 2026/0192723 A1
(43) Pub. Date: Jul. 9, 2026

(54) HEADREST FOR A MOTOR VEHICLE SEAT

(71) Applicant: TREVES PRODUCTS,SERVICES & INNOVATION, Issy-Les-Moulineaux (FR)

(72) Inventors: Xavier BONFILS, Issy-Les-Moulineaux (FR); Eric BRILLON, Issy-Les-Moulineaux (FR); Arnaud DUVAL, Issy-Les-Moulineaux (FR)

(21) Appl. No.: 19/133,730

(22) PCT Filed: Nov. 30, 2023
(86) PCT No.: PCT/EP2023/083848

§ 371 Date: May 29, 2025

(30) Foreign Application Priority Data
Dec. 1, 2022 (FR) FR2212644

(51) Int. Cl. B60N 2/879; B60N 2/80; H04R 1/02; H04R 1/28

(52) U.S. Cl. CPC B60N 2/879; H04R 1/025; H04R 1/288; H04R 1/2888; B60N 2002/899; H04R 2499/13

(57) ABSTRACT

The invention concerns a headrest for a motor vehicle seat, said headrest comprising a support block (1) provided with a padding cushion (2) made of elastically compressible foam, said block being supported by a rigid frame (3) for mounting said headrest at the top of the backrest of said seat, said headrest being equipped with a generator of acoustic waves in the environment of said headrest, the generator comprising at least one plate (6) on which an electrodynamic transducer (7) is provided, said plate being attached to the support block (1) and being arranged to be excited vibrationally by said transducer in order to generate the acoustic waves, the block comprising a support layer (12) arranged on a front surface (11) in front of which the head of the occupant is intended to be, said support layer having a Young's modulus E of less than 40 kPa and an airflow resistivity of less than 5,000 N·m⁻⁴·s.

The invention relates to a headrest for a motor vehicle seat, as well as to an assembly for generating acoustic waves in a motor vehicle passenger compartment comprising such a headrest.

It is known to equip a headrest with an acoustic wave generator enabling a sound signal to be emitted close to the head of an occupant of the seat on which said headrest is mounted. The waves are then generated as close as possible to the user's ears in order to limit acoustic losses.

In addition to an audible signal, the generator can emit an “anti-noise” type sound signal, i.e. in phase opposition to the noise inside the passenger compartment, so as to enable active control of noise within the passenger compartment.

To achieve this, at least one loudspeaker can be integrated into the volume of the headrest. However, the size of a loudspeaker makes it difficult to fit into a piece of small size such as a headrest, and its weight makes the headrest fitted with it noticeably heavier.

In addition, the loudspeakers fitted to the headrests emit at medium and/or high frequencies but, for reasons of size, cannot emit at frequencies below 150 Hz, whereas these low frequencies, in particular frequencies of 100 Hz or even 60 Hz, are necessary for the quality of a sound signal, in particular of the “anti-noise” type.

Acoustic wave generators are known comprising a rigid plate which is excited vibrationally by an electrodynamic transducer in order to generate said waves. The transducer thus allows an electrical control signal to be transformed into an acoustic signal, by using the plate to which it is attached as a radiation surface.

Due to its compactness, this solution makes it possible to limit the space required for the acoustic wave generator to be integrated into a headrest, but generates a significant problem of vibration transmission to said headrest, which can be a source of discomfort in the environment around said headrest, particularly for the passenger seated on the seat equipped with it.

The aim of the invention is to provide a headrest that can overcome these disadvantages, in particular the transmission of vibrations between the headrest and the head of the occupant of the seat on which said headrest is mounted.

To this end, according to a first aspect, the invention proposes a headrest for a motor vehicle seat, said headrest comprising a support block provided with a padding cushion made of elastically compressible foam, said block being supported by a rigid frame for mounting said headrest at the top of the backrest of said seat, said headrest being equipped with a generator of acoustic waves in the environment of said headrest, the generator comprising at least one plate on which an electrodynamic transducer is provided, said plate being attached to the support block and being arranged to be excited vibrationally by said transducer in order to generate the acoustic waves, the block comprising a support layer arranged on a front surface, in front of which the head of the occupant is intended to be, said support layer having a Young's modulus E of less than 40 kPa and an airflow resistivity of less than 5,000 N·m⁻⁴·s.

According to a second aspect, the invention proposes an assembly for generating acoustic waves in a motor vehicle passenger compartment, said assembly comprising such a headrest and a system for controlling at least one transducer to excite vibrationally the plate on which it is provided.

Further features and advantages of the invention will become apparent from the following description, made with reference to the appended figures, in which:

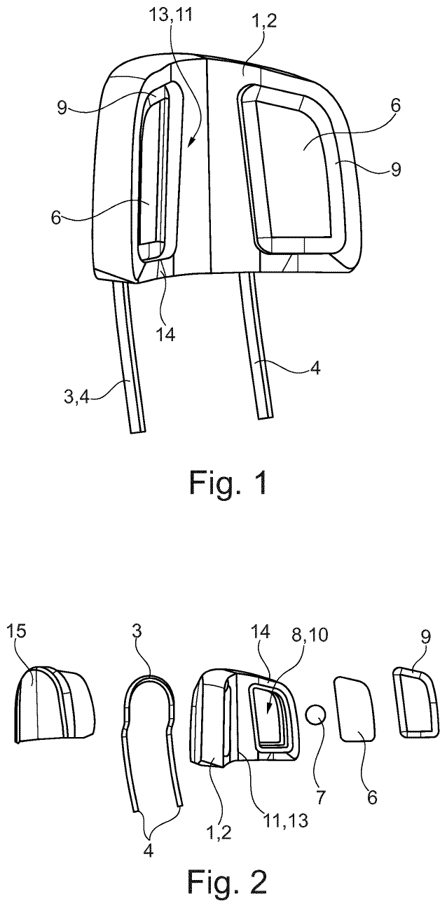

FIG. 1 is a schematic perspective front view of a headrest according to one embodiment of the invention;

FIG. 2 is a schematic exploded perspective front view of the headrest shown in FIG. 1, completed with an appearance layer;

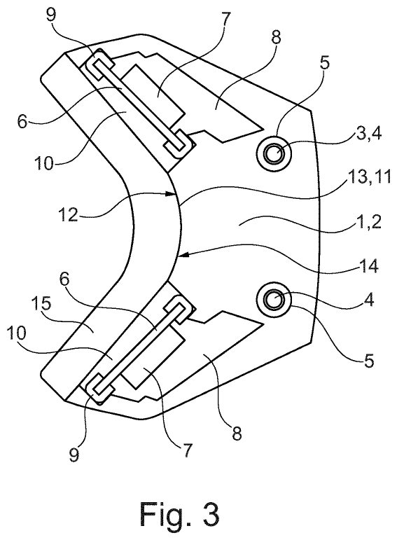

FIG. 3 is a schematic horizontal cross-section view of the headrest shown in FIG. 2.

In relation to these figures, a headrest for a motor vehicle seat is described below, as well as an assembly for generating acoustic waves in a motor vehicle passenger compartment which includes such a headrest.

In this description, the terms of positioning in space (lateral, transverse, top, rear, . . . ) are taken to refer to the headrest positioned in the vehicle in the situation of use.

The headrest comprises a support block 1 provided with a padding cushion 2 made of elastically compressible foam, said block being supported by a rigid frame 3 for mounting said headrest at the top of the backrest of a motor vehicle seat (not shown).

The mounting frame 3 may comprise at least one rod 4, in particular of metallic material, which is fitted into a duct 5 formed in the support block 1.

In particular, the support block 1 can comprise a housing, in particular made of molded plastic material, for absorbing energy in the event of an occupant's head impact, which is surrounded by the padding cushion 2, the duct 5 being formed in said housing.

In the embodiment shown, the mounting frame 3 has an inverted U-shaped geometry, the branches of which form two rods 4, which are each fitted into a respective duct 5 formed in the support block 1.

The cushion 2 may be in the form of a block of molded skin foam, with the skin on the outside, said foam having a hardness greater than 25 shore A, and in particular of the order of 30 shore A.

The foam of support block 1 may also have a density of between 0.20 and 0.30, and in particular of the order of 0.25.

The headrest is equipped with a generator of acoustic waves in the environment of said headrest, the generator comprising at least one plate 6 on which an electrodynamic transducer 7 is provided.

The plate 6 is attached to the support block 1 and arranged to be excited vibrationally by the transducer 7, in order to generate the acoustic waves. The assembly for generating acoustic waves in the passenger compartment includes a system for controlling the transducer 7 so as to excite vibrationally the plate 6 on which it is provided.

In the embodiment shown, the headrest comprises two generators arranged laterally on either side of the support block 1, each comprising a transducer 7 provided on a respective plate 6 to excite it vibrationally, so as to generate acoustic waves on either side of the head of a seat occupant.

In addition, the control system is arranged to drive each of the two transducers 7, either jointly or independently.

The padding cushion 2 is provided with two cavities 8 arranged laterally on either side of the support block 1, and in each of which a plate 6 is attached by its periphery to said padding cushion

In particular, each cavity 8 has an aperture 10 opening into a front surface 11 of the support block 1, in front of which the occupant's head is intended to be, the plate 6 being mounted in said aperture.

The plates 6 each have a Young's modulus E greater than 10 MPa, in particular of between 100 MPa and 1 GPa, so as to have sufficient rigidity to generate acoustic waves without deformation when they are excited vibrationally by their transducer 7.

To prevent the transmission of vibrations generated by the plate 6, the headrest comprises a vibration decoupling means arranged between said plate and said support block.

In particular, the vibration decoupling means comprises two seals 9 made of elastomer material, each of which is interposed between a respective plate 6 and the padding cushion 2, each surrounding the periphery of said plate.

In a variant not shown, the headrest can also include a vibration decoupling means arranged between the support block 1 and the rigid frame 3, in particular in the form of sleeves made of elastomer material each interposed between a rod 4 and its mounting duct 5 in said support block, in order to avoid propagation of vibrations at the level of the mounting of said support block on said frame, and thus avoid propagation of said vibrations from said frame to the backrest of the seat.

The decoupling means 9 comprises an elastomer material with a Young's modulus E of less than 20 kPa, so as to provide sufficient flexibility to decouple the vibratory plate 6 from the support block 1, and possibly to decouple said support block from the frame 3. In particular, the high flexibility of the material enables particularly effective vibratory decoupling at low frequencies, especially below 150 Hz, or even 100 Hz and up to 60 Hz.

In addition, the flexibility of the elastomer material is adapted to allow the decoupling means 9 to withstand the mechanical stresses required for the headrest in the event of the seat occupant's head impacting on it.

The elastomer material is preferably foam-based, in particular polyurethane (PU) foam or EPDM (ethylene propylene diene monomer) foam rubber.

In addition, the elastomer material of the decoupling means 9 has an ETA loss factor greater than 0.2, so as to optimize its decoupling function.

Advantageously, the foam of the cushion 2 is flexible enough to contribute to vibration decoupling between the support block 1 and the plates 6, while being at the same time sufficiently rigid to ensure the holding of said plates in their respective cavities 8. In particular, the foam of the cushion 2 has a Young's modulus E greater than 20 kPa, enabling vibration decoupling at medium and high frequencies.

To prevent the transmission of vibrations from the support block 1 to the seat occupant's head, said block comprises a support layer 12 which is arranged on the front surface 11, in front of which the said head is intended to be, said support layer having a Young's modulus E of less than 40 kPa.

The support layer 12 thus makes it possible to provide the support block 1 with greater flexibility in the area facing the occupant's head, in order to provide localized acoustic decoupling, while retaining greater rigidity in the other areas of the cushion 2, in order to maintain the stresses associated with holding the plates 6 in their cavities 8 and absorbing shocks.

The support layer 12 also has a resistivity to the passage of air of less than 5,000 N·m⁻⁴·s, so as to allow the acoustic waves generated by the vibration of the plates 6 to pass through it, and thus to allow said waves to reach the occupant's ears with preserved quality. The support layer 12 thus forms a solid-state insulating barrier, with both acoustic insulating and damping properties.

In one embodiment, the support layer 12 is formed from a membrane-free, very open-cell foam, in particular with cells of diameter greater than 1 mm, and more particularly of between 2 and 3 mm. This foam may, for example, be of the same type as the foams generally used for wind protection of microphones (so-called “pop-up” foams).

In the embodiment shown, the apertures 10 of the cavities 8 are separated by a central area 13 of the front surface 11, and the support layer 12 covers at least each of these apertures 10 and said central area. Advantageously, the support layer 12 extends over the entire surface of a front wall 14 of the support block 1, thereby enhancing the comfort of the seat occupant.

In addition, the support block 1 is fitted with an appearance layer 15 under which the support layer 12 is arranged, thus improving the aesthetic appearance of the headrest while protecting said support layer.

1. A headrest for a motor vehicle seat, said headrest comprising a support block (1) provided with a padding cushion (2) made of elastically compressible foam, said block being supported by a rigid frame (3) for mounting said headrest at the top of the backrest of said seat, said headrest being equipped with a generator of acoustic waves in the environment of said headrest, said headrest being characterized in that the generator comprises at least one plate (6) on which an electrodynamic transducer (7) is provided, said plate being attached to the support block (1) and being arranged to be excited vibrationally by said transducer in order to generate the acoustic waves, the block comprising a support layer (12) arranged on a front surface (11) in front of which the head of the occupant is intended to be, said support layer having a Young's modulus E of less than 40 kPa and an airflow resistivity of less than 5,000 N·m⁻⁴·s.

2. Headrest according to claim 1, characterized in that the support layer (12) is formed from a membrane-free, very open-cell foam.

3. Headrest according to claim 1, characterized in that the support block (1) is provided with at least one cavity (8) in which the plate (6) is attached, said cavity having an aperture (10) opening into the front surface (11), said aperture being covered by the support layer (12).

4. Headrest according to claim 1, characterized in that it comprises two generators arranged laterally on either side of the support block (1), so as to generate acoustic waves on either side of the head of a seat occupant.

5. Headrest according to claim 1, characterized in that the support block (1) is fitted with an appearance layer (15), the support layer (12) being arranged under said appearance layer.

6. Headrest according to claim 1, characterized in that the support layer (12) extends over the entire surface of a front wall (14) of the support block (1).

7. Headrest according to claim 1, characterized in that it comprises a vibration decoupling means (9) which is arranged between the plate (6) and the support block (1).

8. Headrest according to claim 7, characterized in that the plate (6) is attached to the padding cushion (2), the vibration decoupling means comprising a seal (9) of elastomer material which is interposed between the plate (6) and the padding cushion (2).

9. Headrest according to claim 1, characterized in that the plate (6) has a Young's modulus E which is greater than 10 MPa.

10. An assembly for generating acoustic waves in a motor vehicle passenger compartment, said assembly comprising a headrest according to claim 1, and a system for controlling at least one transducer (7) to excite vibrationally the plate (6) on which it is provided.
